(19) United States
(12) Patent Application Publication
(10) Pub. No.: US 2010/0118808 A1
(43) Pub. Date: May 13, 2010

(54) Method and apparatus for inter-frame sharing in cognitive radio system

(75) Inventors: Cheng Shan, Suwon-si (KR); Eun-Taek Lim, Suwon-si (KR); Jung-Soo Woo, Suwon-si (KR); Ho-Dong Kim, Gwacheon-si (KR); Sang-Bum Kim, Seoul (KR); Yong-Ho Park, Cheonan-si (KR); Geun-Ho Lee, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/590,430

(22) Filed: Nov. 6, 2009

(30) Foreign Application Priority Data
Nov. 7, 2008 (KR) 10-2008-0110238

(51) Int. Cl. H04W 72/04

(52) U.S. Cl. 370/329

(57) ABSTRACT

An operating method of a source Base Station (BS) for inter-frame sharing in a Cognitive Radio (CR) system includes generating a first random number for a frame contention; requesting the frame contention to one or more destination BSs by carrying the first random number; receiving responses for the frame contention request from the one or more destination BSs; and when positive responses for the frame contention request are received from all of the one or more destination BSs, occupying one or more requested contention frames.

### CROSS-REFERENCE TO RELATED APPLICATION(S) AND CLAIM OF PRIORITY

This application claims the benefit under 35 U.S.C. §119 to an patent application filed in the Korean Intellectual Property Office on Nov. 7, 2008 and assigned Serial No. 10-2008-0110238, the contents of which are hereby incorporated by reference.

### TECHNICAL FIELD OF THE INVENTION

The present invention relates generally to a cognitive radio system. More particularly, the present invention relates to a method and an apparatus for inter-frame sharing through contention in the cognitive radio system.

### BACKGROUND OF THE INVENTION

In an environment where various wireless communication systems use different spectrums, supporting high-speed multimedia services by allocating a new frequency band is limited by lack of the frequencies. To address the lack of the frequencies, a Cognitive Radio (CR) technique for increasing the frequency utilization is drawing attention.

While a Primary User (PU) having the exiting frequency license is not using the corresponding band, the CR technique allows a Secondary User (SU) to share the band. The CR technique should be able to protect the PUs and also guarantee Quality of service of the SUs, which is hereafter referred to as self coexistence. To provide broadband wireless access services over the area ranging from tens of kilometers (km) to 100 km, Institute of Electrical and Electronics Engineers (IEEE) 802.22 standardization for sharing the currently allocated broadcast band based on the CR is under process.

In the CR system of the self coexistence function, a base station detects at least one unused channel of the primary/licensed system and communicates over the detected channel. When a plurality of CR systems spatially coexists, the CR systems exchange a Coexistence Beacon Protocol (CBP) packet to raise the spectrum utilization. To facilitate the self coexistence function, the CR system mostly adopts a superframe structure. For example, the IEEE 802.22 standard defines sixteen (16) frames in the time axis as one superframe.

Meanwhile, a conventional system detects an unused channel from the multiple broadcast channels and shares the channel. However, if the available spectrum resources are quite limited, it is necessary for the multiple base stations to share one broadcast channel.

In this respect, a method and an apparatus for the inter-frame sharing in one channel in the CR system are needed.

### SUMMARY OF THE INVENTION

To address the above-discussed deficiencies of the prior art, it is a primary aspect of the present invention to solve at least the above-mentioned problems and/or disadvantages and to provide at least the advantages described below. Accordingly, an aspect of the present invention is to provide a method and an apparatus for inter-frame sharing in a cognitive radio system.

Another aspect of the present invention is to provide a method and an apparatus for efficiently sharing resources through inter-frame sharing in a cognitive radio system.

According to one aspect of the present invention, an operating method of a source Base Station (BS) for inter-frame sharing in a Cognitive Radio (CR) system includes generating a first random number for a frame contention; requesting the frame contention to one or more destination BSs by carrying the first random number; receiving responses for the frame contention request from the one or more destination BSs; and when positive responses for the frame contention request are received from all of the one or more destination BSs, occupying one or more requested contention frames.

According to another aspect of the present invention, an operating method of a source BS for inter-frame sharing in a CR system includes generating a first random number for a frame contention; requesting the frame contention to a corresponding destination BS together the first random number; receiving a response for the frame contention request from the corresponding destination BS, and requesting the frame contention to a next corresponding destination BS by carrying the first random number or a newly generated second random number; and receiving a response for the frame contention request from the next corresponding destination BS.

According to yet another aspect of the present invention, an operating method of a destination BS for inter-frame sharing in a CR system includes receiving a frame contention request comprising a first random number from a source BS; comparing the first random number and a second random number; and responding to the frame request from the source BS according to a comparison result.

According to still yet another aspect of the present invention, an apparatus of a source BS for inter-frame sharing in a CR system includes a random number generator configured to generate a first random number for a frame contention; a controller configured to, request the frame contention to one or more destination BSs with the first random number, and receiving responses for the frame contention request from the one or more destination BSs; and a frame resource arranger configured to, when positive responses are received for the frame contention request from all of the one or more destination BSs, occupy one or more requested contention frames.

According to a further aspect of the present invention, an apparatus of a source BS for inter-frame sharing in a CR system includes a random number generator configured to generate a first random number for a frame contention; and a controller configured to request the frame contention to a corresponding destination BS by carrying the first random number, receive a response for the frame contention request from the corresponding destination BS, request the frame contention to a next corresponding destination BS by carrying the first random number or a newly generated second random number, and receive a response for the frame contention request from the next corresponding destination BS.

According to a further aspect of the present invention, an apparatus of a destination BS for inter-frame sharing in a CR system includes a controller configured to receive a frame contention request comprising a first random number from a source BS; and a frame resource arranger configured to compare the first random number and a second random number. The controller responds to the frame request from the source BS according to a comparison result.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features and advantages of certain exemplary embodiments the present invention will become more apparent from the following detailed description taken in conjunction with the accompanying drawings, in which:

FIG. 1 illustrates a diagram of inter-frame sharing through contention in one channel in a Cognitive Radio (CR) system according to an exemplary embodiment of the present invention;

FIG. 2 illustrates a diagram of the inter-frame sharing process through multicasting in the CR system according to an exemplary embodiment of the present invention;

FIG. 3 illustrates a diagram of the inter-frame sharing process through unicasting in the CR system according to an exemplary embodiment of the present invention;

FIG. 4 illustrates a flowchart of a source base station for the inter-frame sharing through the multicasting in the CR system according to an exemplary embodiment of the present invention;

FIG. 5 illustrates a flowchart of a destination base station for the inter-frame sharing through the unicasting in the CR system according to an exemplary embodiment of the present invention;

FIG. 6 illustrates a flowchart of the source base station for the inter-frame sharing through the unicasting in the CR system according to an exemplary embodiment of the present invention; and

FIG. 7 illustrates a block diagram of the base station for the inter-frame sharing in the CR system according to an exemplary embodiment of the present invention.

Throughout the drawings, like reference numerals will be understood to refer to like parts, components and structures.

### DETAILED DESCRIPTION OF THE INVENTION

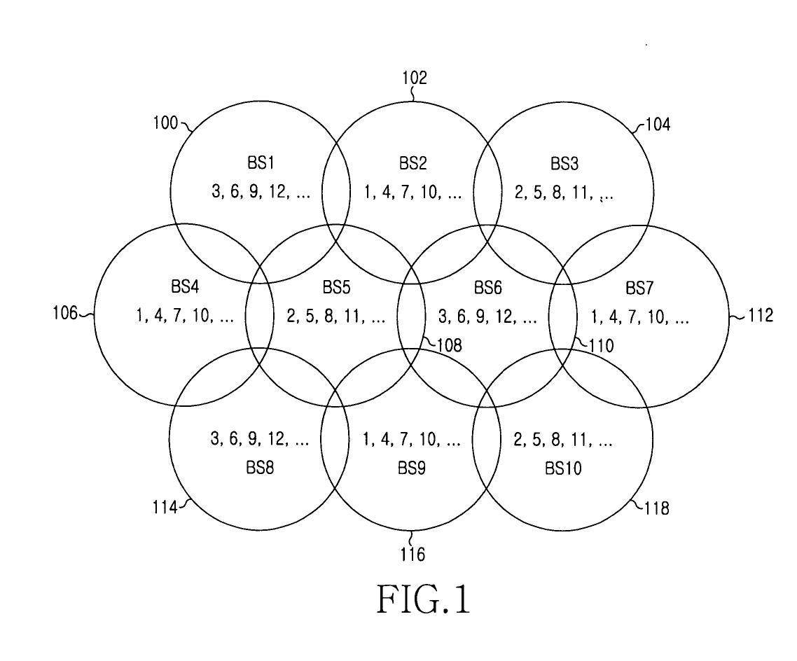

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

Preferred embodiments of the present invention will be described herein below with reference to the accompanying drawings. In the following description, well-known functions or constructions are not described in detail since they would obscure the invention in unnecessary detail. Terminologies described below are defined with consideration of functions in the present invention, and can change depending on the intention or practice of a user or operator. Therefore, the definitions should be determined on the basis of the descriptions over the specification.

Exemplary embodiments of the present invention provide a method and an apparatus for inter-frame sharing through contention in one channel in a Cognitive Radio (CR) system.

To facilitate a self coexistence function in the CR system, Institute of Electrical and Electronics Engineers 802.22 standard primarily adopts a superframe structure. The IEEE 802.22 standard defines sixteen (16) frames in a time domain as one superframe.

In a wireless environment with the limited spectrum resources, when CR systems coexisting in vicinity share and communicate over only one available channel, the spectrum sharing needs to be ensured on the frame basis.

FIG. 1 illustrates the inter-frame sharing through contention in one channel in the CR system according to an exemplary embodiment of the present invention.

Referring to FIG. 1, cells 100 through 118 perform the frame based data transmission according to a transmission scheduling through negotiation. The negotiation is carried out by exchanging Coexistence Beacon Protocol (CBP) packets in a Self Coexistence Window (SCW). In various implementations, frames may be fixedly allocated per cell at the initial phase.

According to the frame scheduling result, it is assumed that the first cell 100, the sixth cell 110, and the eighth cell 114 transmit data in frame intervals 3, 6, 9, 12, and so forth, the second cell 102, the fourth cell 106, the seventh cell 112, and the ninth cell 116 transmit data in frame intervals 1, 4, 7, 10, and so forth, and the third cell 104, the fifth cell 108, and the tenth cell 118 transmit data in frame intervals 2, 5, 8, 11, and so forth. It is assumed that the first cell 100, the sixth cell 110, and the eighth cell 114, which are apart from each other, do not interfere with one another when transmitting data over the same frames. Likewise, the second cell 102, the fourth cell 106, the seventh cell 112, and the ninth cell 116 are apart from one another enough not to interfere with one another, and the third cell 104, the fifth cell 108, and the tenth cell 118 are apart from one another enough not to interfere with one another.

The cells 100 through 118 transmit data by sharing the frames in one channel (hereafter, referred to as inter-frame sharing). A mode of the communication by allocating the frame resources to the cells through the frame scheduling without the contention as shown in FIG. 1 is hereafter referred to as a normal operation mode.

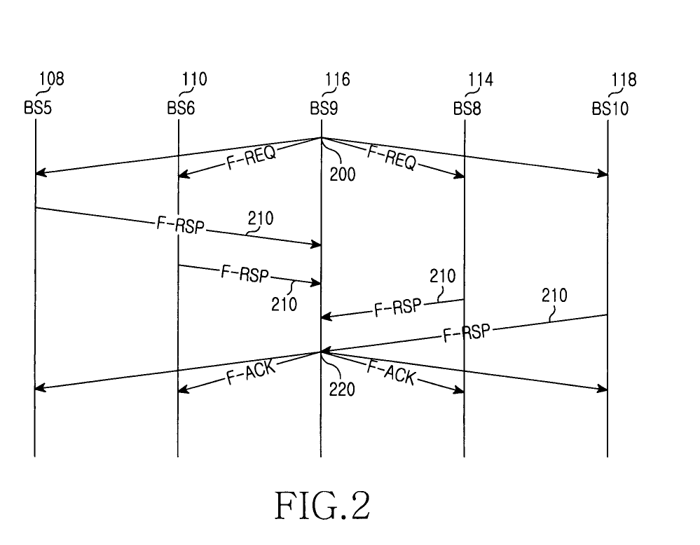

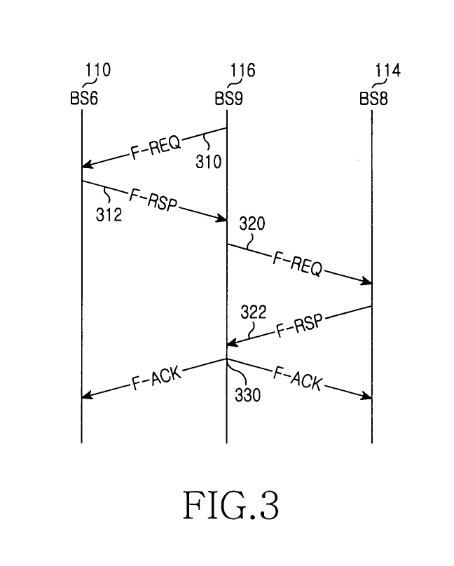

When one or more frames are additionally required in a certain cell in the normal operation mode, the certain cell multicasts or unicasts a frame contention request to the neighboring cells which occupy the frames in the same channel. The neighboring cells compare their generated random number with the random number transmitted from the certain cell and thus respond according to the result of the comparison. The certain cell sends ACK or NACK to the neighboring cells by referring to the feedbacks from the neighboring cells, which shall be described in more detail by referring to FIGS. 2 and 3. Hereinafter, a certain cell or a certain base station which requests the frame contention is referred to as a source cell or a source base station, and the neighboring cell or base station requested for the frame contention is referred to as a destination cell or base station.

FIG. 2 illustrates the inter-frame sharing process through the multicasting in the CR system according to an exemplary embodiment of the present invention. It is assumed that the source cell is the ninth cell 116 (or the BS9) and the destination cells are the fifth cell 108, the sixth cell 110, the eighth cell 114, and the tenth cell 118 (or the BS5, the BS6, the BS8, and the BS10). As described in FIG. 1, it is assumed that the cells share the frames in one channel.

In FIG. 2, when one or more frames are additionally required, the BS9 multicasts the frame contention request to the BS5, the BS6, the BS8, and the BS10 in step 200. In various embodiments, the broadcasting can be employed. The frame contention request is carried by exchanging the CBP packets in the SCW, and includes the random number generated at the BS9 (hereafter, referred to as a first random number) and Base Station Identifier (BSID) information of the destination cells.

In step 210, the BS5, the BS6, the BS8, and the BS10 compare their generated random number (hereafter, referred to as a second random number) with the first random number of the BS9 and send the comparison result to the BS9. For example, when the first random number is greater than the second random number, it implies that the source BS; that is, the BS9 wins in the frame contention. Thus, the destination BSs send a positive response and release the corresponding frame. The corresponding frame is the frame for which the BS9 to vie. Conversely, when the first random number is less than the second random number, it implies that the destination BS; that is, the BS5, the BS6, the BS8, or the BS10 wins in the frame contention. Thus, the destination BSs send a negative response.

When receiving the positive response from all of the destination BSs; that is, from the BS5, the BS6, the BS8, and the BS10, the BS9 occupies one or more frames of the won contention and multicasts or broadcasts an ACK message in step 220.

Although it is not depicted in FIG. 2, when receiving the negative response from one or more destination BSs, the BS9 cannot use the corresponding frame to vie for.

For instance, when the BS9 occupies the frames 1, 4, 7, 10, and so forth and there are no more unoccupied frames in one channel, the BS9 requests the frame contention for the frames 2, 5, 8, 11, and so forth, and 3, 6, 9, 12, and so forth, already occupied by the BS5, the BS6, the BS8 and the BS10, in order to occupy one or more frames in addition. In this situation, the BS9 can request the frame contention by selecting at least one frame or with respect to all of the frames constituting the superframe (e.g., 16 frames form one superframe according to the IEEE 802.22 standard). Next, the BSS, the BS6, the BS8, and the BS10 compare their first random number with the second random number and respond to the BS9 with the comparison result. The BS9 occupies at least one contention frame according to the result.

Table 1 shows the F-REQ message format, Table 2 shows the F-RSP message format, and Table 3 shows the F-ACK message format.

### Table 1

The CH-REQ (F-REQ) message includes source BSID information which requests the channel or the frame, list information of the destination BS(s) receiving the channel or frame request, the requested channel or frame number, channel or frame release time information, and so forth.

### Table 2

The CH-RSP (F-RSP) message includes information of destination BSID which receives the channel or frame request, information of source BSID requesting the channel or the frame, the requested channel or frame number, response type information, and so forth.

### Table 3

The CH-ACK (F-ACK) message includes information of source BSID requesting the channel or the frame, information of destination BSID receiving the channel or frame request, the requested channel or frame number, ACK type information, and so forth.

While the inter-frame sharing through the multicasting is explained in FIG. 2, the inter-frame sharing can be carried out by means of the unicasting.

FIG. 3 illustrates the inter-frame sharing process through the unicasting in the CR system according to an exemplary embodiment of the present invention.

The BS9 of the source cell requests the frame contention to the BS6 in the unicast manner in step 310, and the BS6 compares the first random number and the second random number and responds with the result in step 312. Next, the BS9 requests the frame contention to the BS8 in the unicast manner in step 320, and the BS8 compares the first random number and the second random number and responds with the result in step 322. Although it is not illustrated in FIG. 3, the BS9 unicasts the frame contention request to the BS5 and the BS10 and receives the response from them.

In step 330, the BS9 multicasts or broadcasts the ACK or the NACK to the BS5, the BS6, the BS8 and the BS10 according to the result of the frame contention. For example, when receiving the positive response from all of the BS5, the BS6, the BS8 and the BS10, the BS9 sends the ACK. By contrast, when receiving one or more negative responses, the BS9 sends the NACK.

In various embodiments, the BS9 can unicast the ACK or the NACK. For example, the BS9 can request the frame contention in step 310, receive the response in relation to the frame contention in step 312, and unicast the ACK or the NACK according to the result. Herein, when the BS9 unicasts the frame contention request to the BS5, the BS6, the BS8 and the BS10 in order and sends the NACK to the corresponding destination BS, it is preferable to suspend the request and to request the frame contention for other frame although there still remain the neighboring BSs to which the frame contention needs to be requested.

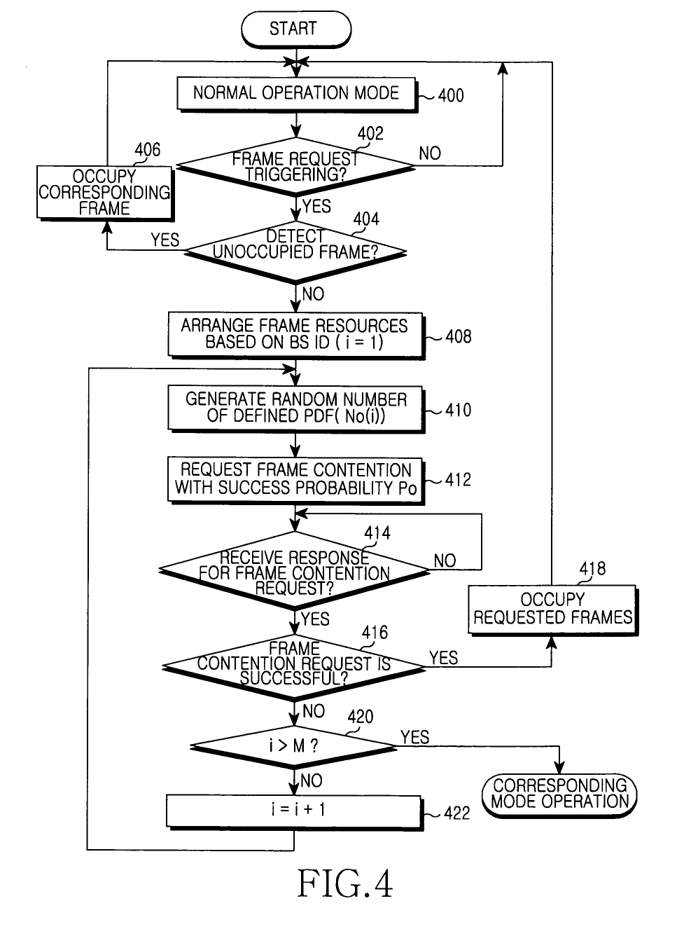

FIG. 4 illustrates a flowchart of the source BS for the inter-frame sharing through the multicasting in the CR system according to an exemplary embodiment of the present invention.

In step 400, the source BS performs the normal operation mode. For example, in the normal operation, the BS9 communicates by occupying the unused frames 1, 4, 7, 10, and so forth, as shown in FIG. 1.

When a frame request triggering occurs in step 402; that is, when the additional frame is required, the source BS determines whether there is an unoccupied frame within the superframe in step 404. Whereas, when the frame request triggering does not occur, the source BS maintains the normal operation in step 400.

When detecting the unoccupied frame in step 404, the source BS occupies the corresponding frame in step 406 and enters the normal operation mode.

Detecting no unoccupied frame in step 404, the source BS arranges the frame resources to compete for in step 408. Provided that the frame resources are allocated as in FIG. 1, the BS9 determines the frame to complete for by arranging the frame resources as shown in Table 4.

TABLE 4

| | | Number of BSs |
|---|---|---|
| Frame index (i) | BSID | occupying frame (L) |
| 1 | 9 | 1 |
| 2 | 5, 10 | 2 |
| 3 | 6, 8 | 2 |
| 4 | 9 | 1 |
| 5 | 5, 10 | 2 |
| 6 | 6, 8 | 2 |
| 7 | 9 | 1 |
| 8 | 5, 10 | 2 |
| 9 | 6, 8 | 2 |
| 10 | 9 | 1 |
| 11 | 5, 10 | 2 |
| 12 | 6, 8 | 2 |
| 13 | 9 | 1 |
| 14 | 5, 10 | 2 |
| 15 | 6, 8 | 2 |
| 16 | 9 | 1 |

Table 1 shows the BSs which occupy the first through sixteenth frames constituting the superframe in view of the BS9. For example, the BS9 occupies the frames 1, 4, 7, 9 and 10, the BS5 and the BS10 occupy the frames 2, 5, 8, 11 and 14, and the BS6 and the BS8 occupy the frames 3, 6, 9, 12 and 15. While the other BS2 and BS7 occupy the frames 1, 4, 7, 9 and 10 besides the BS9, the BS9 is able to use the same frame because it is away from the BS2 and the BS7.

The source BS (the BS9) may request the frame contention with respect to 16 frames individually in order. In various embodiments, the source BS may request the frame contention by selecting the frame to compete for from the 16 frames. For example, since there is no need to compete for the frames 1, 4, 7, 9 and 10 already occupied, the source BS9 may request the frame contention only for the other frames except for the frames 1, 4, 7, 9 and 10. Alternatively, the source BS9 may request the frame contention for the frames 2, 5, 8, 11 and 14 occupied by the destination BS5 and BS10, or for the frames 3, 6, 9, 12 and 15 occupied by the destination BS6 and BS8.

Alternatively, the BS9 requests the frame contention for the other frames 2, 5, 8, 11, 13, 16, 3, 6, 9, 12 and 15 than its occupying frames. When the frame 2 is requested, the BS5 and the BS10 which occupy the frame 2 among the destination BSs (the BS5, the BS6, the BS8 and the BS10) receiving the frame request generates the random number and vies by comparing its random number with the random number of the BS9. By contrast, the BS6 and the BS8, which do not occupy the frame 2, do not perform any operation without having to generate the random number for the frame 2. In other words, the BS6 and the BS8 do not need to compete because they are not occupying the frame 2.

Next, the source BS calculates or generates the random number N₀(i) (hereafter, referred to as a first random number) according to a Probability Density Function (PDF) defined for the arranged frame i in step 410. Herein, i is the frame index and N₀(i) is the random number for the i-th frame of the superframe.

When the random number is generated as an X-bit integer uniformly distributed, the PDF is

$${P}_{{N}_{o}} ( n ) = \frac{1}{X}$$

and the probability that the source BS may win in the contention is

$$\frac{1}{L + 1} .$$

n denotes the generated random number, X denotes the number of bits for representing the random number, and L denotes the number of BSs occupying the frame to vie for.

If the source BS sets the probability of wining in the contention to a different value P₀, P_{N}_{_{O}}(n) can be designed under the condition of Equation 1:

Pr(N₀(i)≧N₁(i), . . . , N_{L}_{_{Frame(i)}}(i))=P₀ [Eqn. 1]

N₀(i) denotes the random number for the i-th frame generated at the source BS, N₁(i) denotes the random number for the i-th frame generated at the first destination BS, and N_{L}(i) denotes the random number for the i-th frame generated at the L-th destination BS.

P_{N}_{_{O}}(n) can be designed as expressed in Equation 2 and Equation 4:

$${P}_{{N}_{o}} ( n ) = \{ \begin{matrix}\frac{1}{X - {X}^{′}} , & {X}^{′} - 1 \leq n \leq X - 1 \\ 0 , & otherwise\end{matrix} \qquad [ Eqn . 2 ]$$

X and X′ denote the number of bits for representing the random number n, and 0≦X′≦X denotes a root which meets Equation 3:

$$\begin{matrix}{( \frac{{X}^{′}}{X} )}^{L + 1} - {P}_{0} ( L - 1 ) ( \frac{{X}^{′}}{X} ) + ( {P}_{0} L - {P}_{0} - 1 ) = 0 , & [ Eqn . 3 ] \\ {P}_{{N}_{0}} ( n ) = , \{ \begin{matrix}1 , & n = [ X \cdot \sqrt[L]{{P}_{0}} ] \\ 0 , & otherwise\end{matrix} & [ Eqn . 4 ]\end{matrix}$$

X and X′ denote the number of bits for representing the random number n, P₀ denotes the probability that the source BS can win in the frame contention, and L denotes the number of BSs taking part in the frame contention. That is, rather than generating the random number, the source BS calculates the random number based on the predefined success probability P₀ and the number of the BSs L in the contention.

Alternatively, the random number may be calculated by taking into account fairness of the occupied frame distribution. In terms of the fairness, it is necessary for the BSs occupying the great number of the frames to less occupy new frames and for the BSs occupying the small number of the frames to occupy more new frames. For doing so, when the frame request is transmitted to the neighboring BSs, the frame request message also includes the number of the frames F_{source} occupied by the source BS. Upon receiving the frame request, the destination BSs generate their random number and increase Pr(N₀(i)≧N₁(i), . . . , N_{L}_{_{Frame(i)}}(i)) for the small F_{source}. When the number of the frames F_{des} occupied by the destination BS is small, the destination BS decreases Pr(N₀(i)≧N₁(i), . . . , N_{L}_{_{Frame(i)}}(i)). For example, the source BS first generates the uniformly distributed random number N₀ and transmits the random number to the plurality of the destination BSs together with the number of the preoccupied frames Fsource. The destination BS computes

$${N}^{′} = [ X \cdot \sqrt[L]{{P}_{0}^{′}} ] .$$

When N₀>N′, the source BS wins in the frame contention. When N₀<N′, the source BS loses in the frame contention.

$${P}_{0}^{′} = min ( \frac{{F}_{des}}{{F}_{source}} {P}_{0} , 1 ) .$$

In the design of P_{N}_{_{O}}(n), the present invention calculates the random number by controlling the final success probability P₀, rather than generating the random variable.

In step 412, the source BS multicasts the frame contention request to one or more destination BSs at the success probability of P₀. For example, when the source BS (the BS9) requests the frame contention for the 16 frames respectively in order in FIG. 1, the frame contention request is multicast to the destination BS5, BS6, BS8 and BS10 determined in step 408. Alternatively, when the BS5 and the BS10 are selected as the destination BSs, the frame contention request is multicast to the BS5 and the BS10.

When receiving the response from the corresponding destination BS in response to the frame contention request in step 414, the source BS determines whether the frame contention request is successful in step 416. When the frame contention request succeeds in step 416; that is, when the positive responses are received from all of the destination BSs, the source BS occupies the requested contention frames in step 418 and enters the normal operation mode. When the frame contention request fails in step 416; that is, when at least one negative response is received from the destination BSs, the source BS checks whether is greater than M in step 420. When i is greater than M, the source BS performs the corresponding mode operation. When i is less than or equal to M, the source BS increases i in step 422 and repeats the steps 410 through 416. The source BS is to request the frame contention for the i frame and then to request the frame contention for the next i+1 frame after it loses in the contention.

Herein, the source BS can attempt the contention for the 16 frames arranged in step 408 or for the selected frames, and occupy the frames of the won contention in step 418. Alternatively, the source BS can vie for the corresponding frame in sequence and occupy only one frame in step 418 when it wins in the contention for one frame.

In various implementations, the source BS can try the frame contention for all of the frames in the frame at the same time.

Next, the source BS finishes this process.

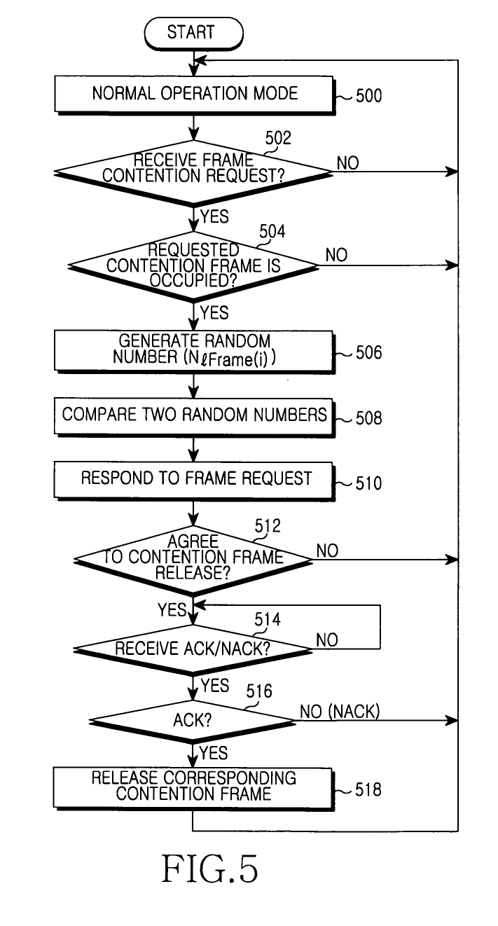

FIG. 5 illustrates a flowchart of the destination BS for the inter-frame sharing through the unicasting in the CR system according to an exemplary embodiment of the present invention. The destination BS (the BS5, the BS6, the BS8, and the BS10 of FIG. 2 or FIG. 3) is a BS in charge of the destination cell.

In step 500, the destination BS performs the normal operation mode. For example, in the normal operation, the BS6 and the BS8 communicate by occupying the frames 3, 6, 9, 12, and so forth, and the BS5 and the BS10 communicate by occupying the frames 2, 5, 8, 11, and so forth, as shown in FIG. 1.

Upon receiving the frame contention request from the source BS in step 502, the destination BS checks whether the requested frame is occupied or not in step 504. Receiving no frame contention request, the destination BS sustains the normal operation mode in step 500. The received frame contention request includes the first random number generated by the source BS.

When the requested contention frame is not occupied in step 504, the destination BS sustains the normal operation mode in step 500. When the requested contention frame is occupied by the destination BS, the destination BS generates a local random number N₁_{_{Frame(i)}}(i) (hereafter, referred to as a second random number) in step 506.

Next, the destination BS compares the first random number and the second random number in step 508 and sends the response for the frame contention request to the source BS in step 510. More specifically, when the first random number is greater than the second random number, this implies that the source BS wins in the frame contention and the destination BS sends the positive response. When the first random number is smaller than the second random number, this implies that the source BS loses in the frame contention and the destination BS sends the negative response.

When not agreeing to the contention frame release in step 512, the destination BS sustains the normal operation mode in step 500. By contrast, when agreeing to the contention frame release, the destination BS receives ACK or NACK in step 514.

Upon receiving the ACK in step 516, the destination BS releases the corresponding contention frame in step 518. Conversely, upon receiving the NACK, the destination BS sustains the normal operation mode in step 500.

Next, the destination BS finishes this process.

While the frame contention request is attempted through the multicasting between the source BS and the destination BSs, the frame contention may be requested per destination BS through the unicasting in various implementations in order to reduce the communication overhead between the BSs.

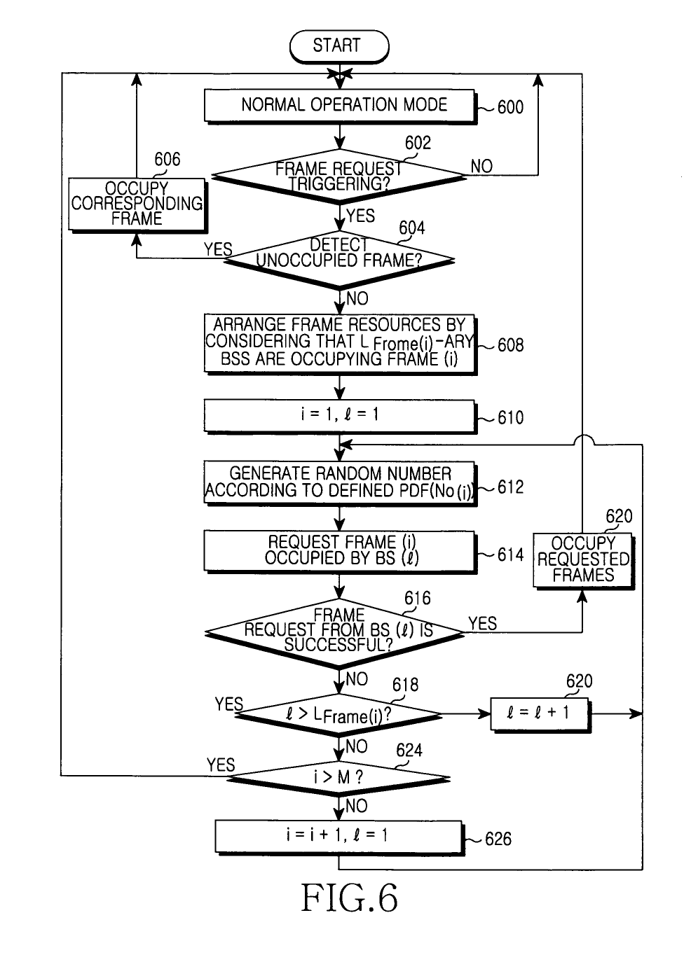

FIG. 6 illustrates a flowchart of the source BS for the inter-frame sharing through the unicasting in the CR system according to an exemplary embodiment of the present invention.

In step 600, the source BS enters the normal operation mode. For example, in the normal operation, the BS9 communicates by occupying the unoccupied frames 1, 4, 7, 10, as shown in FIG. 1.

When a frame request triggering occurs in step 602; that is, when the additional frame is required, the source BS checks whether there is an unoccupied frame within the superframe in step 604. By contrast, when the frame request triggering does not occur, the source BS maintains the normal operation in step 600.

When detecting the unoccupied frame in step 604, the source BS occupies the corresponding frame in step 606 and enters the normal operation mode.

Detecting no unoccupied frame in step 604, the source BS arranges the frame resources according to the BS ID and the number of the BSs occupying the corresponding frame in step 608. This is to request the frame contention using the unicasting per BS occupying the i frame according to the value 1.

In step 610, the source BS sets i=1 and 1=1 (one). i indicates the frame index and 1 indicates the BS occupying the i frame.

Next, the source BS generates the random number N₀(i) (hereafter, referred to as a first random number) according to the defined PDF in step 612. Herein, is the frame index and N₀(i) is the random number for the i-th frame of the superframe. The generation of the random number is described in detail by referring to FIG. 4.

In step 614, the source BS unicasts the frame contention request to the corresponding destination BS 1 at the success probability of P₀.

In step 616, the source BS determines whether the frame contention request is successful. When the frame contention request is successful in step 616; that is, when the positive responses are received from all of the corresponding destination BSs, the source BS occupies the requested contention frames in step 620 and enters the normal operation mode. By contrast, when the frame contention request fails in step 616; that is, when the negative response is received from the destination BS, the source BS compares 1 and L_{Frame(i)} in step 618. When 1 is greater than L_{Frame(i)}, the source BS proceeds to step 624. When 1 is less than or equal to L_{Frame(i)}, the source BS sets 1=1+1 in step 622. L_{Frame(i)} denotes the number of the BSs occupying the i frame and 1 denotes the BS occupying the i frame. Accordingly, 1 is compared with L_{Frame(i)} in order to request the frame contention to each individual BS occupying the i frame.

In step 624, the source BS checks whether i is greater than M. When i is greater than M, the source BS performs the corresponding mode operation in step 600. By contrast, when i is less than or equal to M, the source BS sets i=i+1 and 1=1 in step 626 and repeats the steps 612 through 616. This is to request the frame contention to each individual BS occupying the i frame based on step 618 and then request the frame contention to each BS occupying the i+1 frame.

Next, the source BS finishes this process.

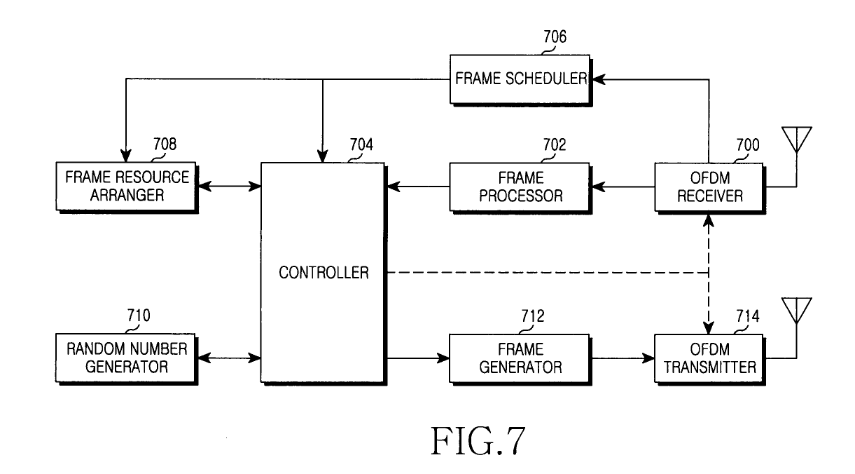

FIG. 7 illustrates a block diagram of the BS for the inter-frame sharing in the CR system according to an exemplary embodiment of the present invention.

The BS of FIG. 7 includes an Orthogonal Frequency Division Multiplexing (OFDM) receiver 700, a frame processor 702, a controller 704, a frame generator 712, an OFDM transmitter 714, a frame scheduler 706, a frame resource arranger 708, and a random number generator 710.

The OFDM receiver 700 converts a Radio Frequency (RF) signal received from the neighboring BS or a terminal to a baseband signal and converts the baseband analog signal to digital sample data. The OFDM receiver 700 outputs subcarriers values by OFDM-demodulating the sample data. Herein, the OFDM demodulation includes Cyclic Prefix (CP) elimination, Fast Fourier Transform (FFT) operation, and so forth.

The frame processor 702 processes the data based on the frame output from the OFDM receiver 700 and provides the result to the controller 704.

The controller 704 controls the operations of the BS, performs the corresponding processing on the information output from the frame processor 702, and provides the result to the frame generator 712.

The frame generator 712 constitutes the information fed from the controller 704 into the corresponding frame region occupied and outputs the frame to the OFDM transmitter 714 of the physical layer.

The OFDM transmitter 714 encodes and modulates the data output from the frame generator 712 at a preset modulation level (Modulation and Coding Scheme (MCS) level). The OFDM transmitter 714 outputs sample data (OFDM symbols) by Inverse FFT (IFFT)-processing the modulated data. After converting the sample data to an analog signal, the OFDM transmitter 714 converts the analog signal to an RF signal and then sends the RF signal over an antenna.

The frame scheduler 706 determines the frame to use using the CBP packet OFDM-demodulated by the OFDM receiver 700 and provides the result to the controller 704.

In the operations of the source BS, the controller 704 requests the frame contention to one or more destination BSs by including the first random number and receives the responses for the frame contention request from the one or more destination BSs. When the positive responses are received from all of the one or more destination BSs in relation to the frame contention request, the frame resource arranger 708 occupies the one or more requested contention frames. The controller 704 sends the ACK for the positive responses to the one or more destination BSs.

Herein, when one or more negative responses are received from the one or more destination BSs in relation to the frame request, the random number generator 710 generates the second random number for the next frame contention. The controller 704 requests the frame contention to the one or more destination BSs by including the second random number and receives the responses for the frame contention request from the one or more destination BSs. When the positive responses are received for the frame contention request from all of the one or more destination BSs, the frame resource arranger 708 occupies the one or more requested contention frames. The controller 704 sends the ACK for the positive response to the one or more destination BSs. The controller 704 sends the NACK for the negative response to the one or more destination BSs. The frame contention request targets every frame in the superframe, or one or more selected frames in the superframe.

When there are one or more unoccupied frames before the frame contention request, the frame resource arranger 708 occupies the one or more unoccupied frames.

Alternatively, in the operations of the source BS, the controller 704 requests the frame contention to the corresponding destination BS by including the first random number, receives the response of the frame contention request from the corresponding destination BS, requests the frame contention to the next corresponding destination BS by including the first random number or the second random number newly generated, and receives the response of the frame contention request from the next corresponding destination BS. When the positive responses are received for the frame request from the corresponding destination BSs, the frame resource arranger 708 occupies the corresponding contention frame.

Meanwhile, when one or more negative responses are received for the frame request from the corresponding destination BSs, the random number generator 710 generates a third random number for the next frame contention. The controller 704 requests the frame contention to the corresponding destination BS by including the third random number, receives the response for the frame contention request from the corresponding destination BS, requests the frame contention to the next corresponding destination BS by including the third random number or a newly generated random number, and receives the response of the frame contention request from the next corresponding destination BS.

In the operations of the destination BS, the controller 704 receives the frame request from the source BS with the first random number included, the frame resource arranger 708 compares the first random number and the second random number, and the controller 704 responds to the frame request from the source BS according to the result of the comparison.

The frame resource arranger 708 releases the requested contention frame when the first random number is greater than the second random number, and keeps occupying the requested contention frame when the first random number is less than or equal to the second random number.

When the first random number is greater than the second random number, the controller 704 sends the positive response to the source BS. When the first random number is less than or equal to the second random number, the controller 704 sends the negative response.

The random number generator 710 generates the random number for the frame contention according to the predefined PDF under the control of the controller 704 and provides the generated random number to the controller 704.

As set forth above, by virtue of the inter-frame sharing in the CR system, the efficient resource utilization can be accomplished in the wireless environment under the limited spectrum resources.

While the invention has been shown and described with reference to certain exemplary embodiments thereof, it will be understood by those skilled in the art that various changes in form and details may be made therein without departing from the spirit and scope of the invention as defined by the appended claims and their equivalents.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An operating method of a source Base Station (BS) for inter-frame sharing in a Cognitive Radio (CR) system, the method comprising:
generating a first random number for a frame contention;
requesting the frame contention to one or more destination BSs corresponding to the first random number;
receiving responses for the frame contention request from the one or more destination BSs; and
occupying one or more requested contention frames, when positive responses for the frame contention request are received from all of the one or more destination BSs.

2. The operating method of claim 1, further comprising:
sending Acknowledgement (ACK) for the positive responses to the one or more destination BSs.

3. The operating method of claim 1, further comprising, when one or more negative responses are received for the frame request from the one or more destination BSs:
generating a second random number for a next frame contention;
requesting the frame contention to the one or more destination BSs together the second random number;
receiving responses of the frame contention request from the one or more destination BSs; and
occupying one or more requested contention frames when positive responses are received for the frame contention request from all of the one or more destination BSs,
wherein ACK for the positive response is transmitted to the one or more destination BSs.

4. The operating method of claim 3, further comprising:
sending Negative ACK (NACK) for the negative response to the one or more destination BSs.

5. The operating method of claim 1, wherein the first random number and the second random number are determined by a predefined Probability Density Function (PDF), and
the predefined PDF is either a first equation or a second equation, the first equation defined as:
$${P}_{{N}_{0}} ( n ) = \{ \begin{matrix}\frac{1}{X - {X}^{′}} , & {X}^{′} - 1 \leq n \leq X - 1 \\ 0 , & otherwise\end{matrix}$$
where X and X′ denote the number of bits for representing a random number n, and X and X′ are roots that satisfy 0≦X′≦X and
$${( \frac{{X}^{′}}{X} )}^{L + 1} - {P}_{0} ( L - 1 ) ( \frac{{X}^{′}}{X} ) + ( {P}_{0} L - {P}_{0} - 1 ) = 0 ,$$
and wherein the second equation is defined as:
$${P}_{{N}_{0}} ( n ) = , \{ \begin{matrix}1 , & n = [ X \cdot \sqrt[L]{{P}_{0}} ] \\ 0 , & otherwise\end{matrix}$$
where X denotes the number of bits for representing the random number n, P₀ denotes a probability that the source BS wins in the frame contention, and L denotes the number of BSs taking part in the frame contention.

6. The operating method of claim 1, wherein the frame contention request targets every frame in a superframe, or one or more selected frames in a superframe.

7. The operating method of claim 1, wherein, before the frame contention request, when there exist one or more frames unoccupied, the one or more unoccupied frames are occupied.

8. An operating method of a source Base Station (BS) for inter-frame sharing in a Cognitive Radio (CR) system, the method comprising:
generating a first random number for a frame contention;
requesting the frame contention to a corresponding destination BS with the first random number;
receiving a response for the frame contention request from the corresponding destination BS, and requesting the frame contention to a next corresponding destination BS together the first random number or a newly generated second random number; and
receiving a response for the frame contention request from the next corresponding destination BS.

9. The operating method of claim 8, wherein, when positive responses are received for the frame request from all of the corresponding destination BSs, a corresponding contention frame is occupied and Acknowledgement (ACK) is transmitted to the corresponding destination BSs.

10. The operating method of claim 8, further comprising, when one or more negative responses are received for the frame request from the corresponding destination BSs:
generating a third random number for a next frame contention;
requesting the frame contention to the corresponding destination BS together the third random number;
receiving a response of the frame contention request from the corresponding destination BS, and requesting the frame contention to a next corresponding destination BS by carrying the third random number or a newly generated random number; and
receiving a response for the frame contention request from the next corresponding destination BS.

11. The operating method of claim 8, wherein the generated random numbers are determined by a predefined Probability Density Function (PDF), and
the predefined PDF one of a first equation and a second equation, the first equation defined as:
$${P}_{{N}_{0}} ( n ) = \{ \begin{matrix}\frac{1}{X - {X}^{′}} , & {X}^{′} - 1 \leq n \leq X - 1 \\ 0 , & otherwise\end{matrix}$$
where X and X′ denote the number of bits for representing a random number n, and X and X′ are roots which satisfy 0≦X′≦X and
$${( \frac{{X}^{′}}{X} )}^{L + 1} - {P}_{0} ( L - 1 ) ( \frac{{X}^{′}}{X} ) + ( {P}_{0} L - {P}_{0} - 1 ) = 0 ,$$
and the second equation is defined as:
$${P}_{{N}_{0}} ( n ) = , \{ \begin{matrix}1 , & n = [ X \cdot \sqrt[L]{{P}_{0}} ] \\ 0 , & otherwise\end{matrix}$$
where X denotes the number of bits for representing the random number n, P₀ denotes a probability that the source BS wins in the frame contention, and L denotes the number of BSs taking part in the frame contention.

12. The operating method of claim 8, wherein the frame contention request targets every frame in a superframe, or one or more selected frames in a superframe.

13. An operating method of a destination Base Station (BS) for inter-frame sharing in a Cognitive Radio (CR) system, the method comprising:
receiving a frame contention request together a first random number from a source BS;
comparing the first random number and a second random number; and
responding to the frame request from the source BS according to a comparison result.

14. The operating method of claim 13, further comprising:
generating the second random number.

15. The operating method of claim 13, further comprising:
releasing the requested contention frame when the first random number is greater than the second random number, and keeping occupying the requested contention frame when the first random number is less than or equal to the second random number.

16. The operating method of claim 13, wherein a positive response is transmitted to the source BS when the first random number is greater than the second random number, and a negative response is transmitted when the first random number is less than or equal to the second random number.

17. An apparatus of a source Base Station (BS) for inter-frame sharing in a Cognitive Radio (CR) system, the apparatus comprising:
a random number generator configured to generate a first random number for a frame contention;
a controller configured to request the frame contention to one or more destination BSs by carrying the first random number, and receive responses for the frame contention request from the one or more destination BSs; and
a frame resource arranger configured to, when positive responses are received for the frame contention request from all of the one or more destination BSs, occupy one or more requested contention frames.

18. The apparatus of claim 17, wherein the controller is configured to send Acknowledgement (ACK) for the positive responses to the one or more destination BSs.

19. The apparatus of claim 17, wherein, when one or more negative responses are received for the frame request from the one or more destination BSs,
the random number generator is configured to generate a second random number for a next frame contention,
the controller is configured to request the frame contention to the one or more destination BSs by carrying the second random number, and receive responses of the frame contention request from the one or more destination BSs,
when positive responses are received for the frame contention request from all of the one or more destination BSs, the frame resource arranger is configured to occupy one or more requested contention frames, and
the controller is configured to send ACK for the positive response to the one or more destination BSs.

20. The apparatus of claim 19, wherein the controller is configured to send Negative ACK (NACK) for the negative response to the one or more destination BSs.

21. The apparatus of claim 17, wherein the first random number and the second random number are determined by a predefined Probability Density Function (PDF), and
the predefined PDF is one of a first equation and a second equation, the first equation defined as:
$${P}_{{N}_{0}} ( n ) = \{ \begin{matrix}\frac{1}{X - {X}^{′}} , & {X}^{′} - 1 \leq n \leq X - 1 \\ 0 , & otherwise\end{matrix}$$
where X and X′ denote the number of bits for representing a random number n, and X and X′ are roots which satisfy 0≦X′≦X and
$${( \frac{{X}^{′}}{X} )}^{L + 1} - {P}_{0} ( L - 1 ) ( \frac{{X}^{′}}{X} ) + ( {P}_{0} L - {P}_{0} - 1 ) = 0 ,$$
and the second equation is defined as:
$${P}_{{N}_{0}} ( n ) = , \{ \begin{matrix}1 , & n = [ X \cdot \sqrt[L]{{P}_{0}} ] \\ 0 , & otherwise\end{matrix}$$
where X denotes the number of bits for representing the random number n, P₀ denotes a probability that the source BS wins in the frame contention, and L denotes the number of BSs taking part in the frame contention.

22. The apparatus of claim 17, wherein the frame contention request targets every frame in a superframe, or one or more selected frames in a superframe.

23. The apparatus of claim 17, wherein, before the frame contention request, when there exists one or more frames unoccupied, the one or more unoccupied frames are occupied.

24. An apparatus of a source Base Station (BS) for inter-frame sharing in a Cognitive Radio (CR) system, the apparatus comprising:
a random number generator configured to generate a first random number for a frame contention; and
a controller configured to request the frame contention to a corresponding destination BS by carrying the first random number, receive a response for the frame contention request from the corresponding destination BS, request the frame contention to a next corresponding destination BS by carrying the first random number or a newly generated second random number, and receive a response for the frame contention request from the next corresponding destination BS.

25. The apparatus of claim 24, further comprising:
a frame resource arranger configured to, when positive responses are received for the frame request from all of the corresponding destination BSs, occupy a corresponding contention frame.

26. The apparatus of claim 24, wherein, when one or more negative responses are received for the frame request from the corresponding destination BSs,
the random number generator is configured to generate a third random number for a next frame contention,
the controller is configured request the frame contention to a corresponding destination BS by carrying the third random number, receive a response of the frame contention request from the corresponding destination BS, request the frame contention to a next corresponding destination BS by carrying the third random number or a newly generated random number, and receive a response for the frame contention request from the next corresponding destination BS.

27. The apparatus of claim 24, wherein the generated random numbers are determined by a predefined Probability Density Function (PDF), and
the predefined PDF is one of a first equation and a second equation, the first equation defined as:
$${P}_{{N}_{0}} ( n ) = \{ \begin{matrix}\frac{1}{X - {X}^{′}} , & {X}^{′} - 1 \leq n \leq X - 1 \\ 0 , & otherwise\end{matrix}$$
where X and X′ denote the number of bits for representing a random number n, and X and X′ are roots which satisfy 0≦X′≦X and
$${( \frac{{X}^{′}}{X} )}^{L + 1} - {P}_{0} ( L - 1 ) ( \frac{{X}^{′}}{X} ) + ( {P}_{0} L - {P}_{0} - 1 ) = 0 ,$$
and the second equation is defined as:
$${P}_{{N}_{0}} ( n ) = , \{ \begin{matrix}1 , & n = [ X \cdot \sqrt[L]{{P}_{0}} ] \\ 0 , & otherwise\end{matrix}$$
where X denotes the number of bits for representing the random number n, P₀ denotes a probability that the source BS wins in the frame contention, and L denotes the number of BSs taking part in the frame contention.

28. The apparatus of claim 24, wherein the frame contention request targets every frame in a superframe, or one or more selected frames in a superframe.

29. An apparatus of a destination Base Station (BS) for inter-frame sharing in a Cognitive Radio (CR) system, the apparatus comprising:
a controller configured to receive a frame contention request comprising a first random number from a source BS; and
a frame resource arranger configured to compare the first random number and a second random number,
wherein the controller is configured to respond to the frame request from the source BS according to a comparison result.

30. The apparatus of claim 29, further comprising:
a random number generator configured to generate the second random number.

31. The apparatus of claim 29, wherein the frame resource arranger is configured to release the requested contention frame when the first random number is greater than the second random number, and keeps occupying the requested contention frame when the first random number is less than or equal to the second random number.

32. The apparatus of claim 29, wherein the controller is configured to send a positive response to the source BS when the first random number is greater than the second random number, and send a negative response when the first random number is less than or equal to the second random number.
